(19) United States
(12) Patent Application Publication
(10) Pub. No.: US 2008/0274445 A1
(43) Pub. Date: Nov. 6, 2008

(54) Reversal Magnetic Display Panel

(75) Inventors: Shinichi Murakata, Kanagawa (JP); Toshihide Kawasaki, Kanagawa (JP); Syunsuke Kajiwara, Kanagawa (JP); Hideki Misawa, Kanagawa (JP); Ryusuke Sakuma, Kanagawa (JP); Takeo Yokoyama, Kanagawa (JP)

Correspondence Address: FOLEY AND LARDNER LLP;SUITE 500, 3000 K STREET NW, WASHINGTON, DC, 20007, US

(73) Assignee: Kabushiki Kaisha Pilot Corporation (Also Trading as Pilot Corporation), Tokyo (JP)

(21) Appl. No.: 10/585,969

(22) PCT Filed: Jan. 20, 2005
(86) PCT No.: PCT/JP2005/000653

§ 371 Date: Jul. 13, 2006

(30) Foreign Application Priority Data
Jan. 29, 2004 (JP) 2004-021122

(51) Int. Cl. B43L 1/00

(52) U.S. Cl. 434/409

(57) ABSTRACT

A reversal magnetic display panel where the numbers of writes/erases repeated until the micro magnets in a dispersion liquid sealed in multiple small cells formed between substrates sediment in the lower part of the small cells by repeated writes/erases when the reversal magnetic display panel is used in a vertical position are increased and a favorable display/erase performance is achieved. Between substrates, a dispersion liquid containing a dispersion medium and a thickening agent as main components and further containing micro magnets the both sides of each of which are differently colored are sealed in. Writing is constituted by difference in contrast between the color of the reversed micro magnets and the color of the non-reversed ones. Hollow particles are mixed with the micro magnets so as to reduce the ratio of the specific gravity of the micro magnets to that of the liquid. The residual magnetization per unit mass of the micro magnets is 1.0 to 23.1 A·m²/Kg

### TECHNICAL FIELD

The present invention relates to a reversal magnetic display panel, in which a liquid dispersion where minute magnets having different colors in the front and back are included in a liquid having a dispersion medium and a thickener as principal components is enclosed between substrates, so that handwriting is formed by reversing the minute magnets and by way of a difference in contrast between a color of the minute magnet which is reversed and that of the minute magnet which is not reversed.

### BACKGROUND ART

Conventionally, a magnetic display panel is known which allows handwriting and erasing by way of magnetism of a magnetic field. Furthermore, a so-called reversal magnetic display panel is also known in which a liquid dispersion having minute magnets whose front and back are differently colored are included in a liquid having a dispersion medium and a thickener as principal components is enclosed between substrates, and a magnetic field is applied to a dispersion system of this liquid dispersion and reverses some of the above-mentioned minute magnets, to thereby perform writing and erasing by way of a difference in contrast between a color of the minute magnet which is reversed and that of the minute magnet which is not reversed (for example, see patent document 1).

Hereafter, a reversal magnetic display panel will be briefly described with reference to the drawings.

FIG. 1 is a front view of a writing board using the reversal magnetic display panel. As shown in FIG. 1, a reversal magnetic display panel 1 has a use as a writing board A like a blackboard or a white board, and it may be used in a situation where it is stood. A structure of the magnetic display panel 1 is such that a large number of independent cells 6 as shown in FIG. 3 are formed with a honeycomb board 5 interposed between a front substrate 2 and a back substrate 3, and a liquid dispersion 4 in which minute magnets 7 are dispersed is enclosed in each of the cells 6.

As for handwriting on the thus formed magnetic display panel 1, handwriting is carried out by means of a magnetic writing pen B (which is moved on a display surface 2a in a direction as indicated by an arrow) as shown in a schematic vertical sectional view of FIG. 2. The minute magnets 7 at a portion where the magnetic writing pen B is moved are reversed, so that handwriting is formed with the difference in contrast between a color of the reversed minute magnets 7a and that of the minute magnets 7 which are not reversed. Reference numeral 10 is a back board member having a structure in which a shock absorbing material 12 is held between two steel plates 11.

In order to erase the above-mentioned handwriting, as shown in FIG. 7, an eraser C which is a flat magnet 13 whose front and back are respectively S pole and N pole and which is arranged so that the same poles (N pole in FIG. 7) as a magnetic pole on the surface side of the reversed minute magnet 7 may face each other via the front substrate 2 is moved along the front substrate 2 (on the reversed minute magnets 7a) where the handwriting is formed. Thus, the reversed minute magnets 7a forming the handwriting are re-reversed to erase the handwriting.

Incidentally, as for a system in which display is carried out such that the magnetic material is caused to migrate in a solvent by means of a magnet (migration type), it is known to add a thickener to the solvent in order to hold the magnetic material. Also in the present invention, in order to maintain the minute magnets in a predetermined position, the thickener is used, whereby the minute magnets are clustered and held near the front substrate.

However, even if the position is held by the thickener, when the panel is set up vertically and used as shown in FIG. 1, erasing operation reverses the minute magnets. Thus, a yield point maintained by the thickener may disappear momentarily around the reversed minute magnet, during which time the power of holding the minute magnet is lost. By repeating this, the minute magnets move downward in the cell gradually, and gather collectively. In such a situation, a problem arises in that approximately 30% part of a surface area of each cell 6 as shown in FIG. 5 is in a transparent or translucence state 8 and a clear handwriting may not be obtained.

Therefore, when such a phenomenon, as mentioned above, occurs, a maintenance plate D constituted by a plurality of magnets 14 so that N poles and S poles are alternately arranged at a specific magnetization pitch as shown in FIG. 6, needs to be shuttled on the display surface 2a several times vertically and horizontally, to continually reverse and re-reverse the minute magnets 7 which are stirred in the liquid dispersion 4. It is also necessary to raise the minute magnets 7 which have moved downward in the cell 6 to return the minute magnets 7 to the original state (state as shown in FIG. 4).

Such work, as mentioned above, is troublesome for the user, and requires improvement. Thus, in order to meet such a demand, the present inventors studied many items aiming to greatly increase the number of times of writing/erasing until it became necessary to return the minute magnets into their original state. As a result, the present inventors came to realization that, as a means of suppressing sedimentation of the minute magnets, it was effective to reduce a ratio of a specific gravity of the minute magnets to a specific gravity of a liquid in the liquid dispersion, and resulted in the present invention.

Incidentally, patent document 2 where an invention concerning “magnetic migration display panel” is disclosed describes a technique in which a magnetic particle is porous. However, the minute magnets in the reversal magnetic display panel which have a magnetic particle with a size of 10-150 μm are obtained such that a first layer where coloring agents, such as a titanium oxide, are dispersed in an epoxy resin etc., is coated with a second magnetic layer comprising magnetic powder and coloring agents, such as carbon black, as disclosed in patent document 1. The magnetic powder at this time is 1-2 μm in size, and mixed only by less than approximately 10% by weight of a weight of the minute magnets. Even if it employs the technique as described in the above-mentioned patent document 2, the specific gravity of the minute magnets cannot be reduced for solving the problems as mentioned above.

Further, in patent document 3, it is proposed to disperse plastic particles containing magnetic powder in a dispersion medium, which is used as a suspension to improve performances as a magnet reader. This discloses that the magnetic particles are chosen to be particles having a specific gravity smaller than that of conventional metal particles, thus solving a problem that the particles sediment within a solvent, the particles must be re-dispersed each time they are used, a display surface must be kept level in order to check magnetic-flux distribution over a long time, etc.

However, when they are used as the magnet reader, this technique requires for minute sensitivity and does not provide a yield point by adding a thickener to the dispersion medium. If they are used for the reversal magnetic display panel of the present invention, the plastic particles containing magnetic powder coagulate at the time of writing so that a clear writing line may not be obtained. In addition to this, the plastic particles containing the above-mentioned magnetic powder do not primarily serve as the minute magnets of the reversal magnetic display panel.

Patent document 1: Japanese Patent Publication No. S59-32796

Patent document 2: Japanese Patent Publication No. H8-7532

Patent document 3: Japanese Patent Publication (KOKAI) No. S61-179423

### DISCLOSURE OT THE INVENTION

### Problems to be Solved by the Invention

The present invention aims to provide a reversal magnetic display panel, wherein when it is used in a situation where it is stood, in order to prevent minute magnets of a liquid dispersion enclosed in a large number of cells formed between substrates from easily sedimenting downward in each cell by repeating writing/erasing, a ratio of a specific gravity of the minute magnets to a specific gravity of a liquid in the liquid dispersion is reduced to greatly increase the number of times of writing/erasing until it needs a multi-pole magnet (maintenance plate) in which N poles and S poles are alternately arranged at a specific magnetization pitch and a good display/erase performance is obtained.

### Means to Solve the Problems

The present invention provides a reversal magnetic display panel, in which a liquid dispersion where minute magnets having different colors in the front and back are included in a liquid having a dispersion medium and a thickener as principal components is enclosed between substrates, so that handwriting is formed by reversing the minute magnets and by way of a difference in contrast between a color of the minute magnet which is reversed and that of the minute magnet which is not reversed, characterized in that the above-mentioned minute magnets include hollow particles, and remanent magnetization per unit mass of the above-mentioned minute magnets is 1.0-23.1 A·m²/kg.

The present invention further provides a reversal magnetic panel, characterized in that a ratio of a specific gravity of the above-mentioned minute magnets to a specific gravity of the liquid having the dispersion medium and the thickener as the principal components is 0.9-2.2.

The present invention further provides a reversal magnetic panel, characterized in that the ratio of the specific gravity of the above-mentioned minute magnets to the specific gravity of the liquid having the dispersion medium and the thickener as the principal components is 1.0-1.9.

In the present invention, the magnetic display panel in which the liquid dispersion is enclosed between the substrates may only be one in which the liquid dispersion is enclosed between the substrates. In general, a large number of cells which are each independent are formed between the substrates, the liquid dispersion is put into each cell, where surroundings are enclosed with a shuttering board or an adhesive.

The cells can be formed by interposing a multi-cell board of a honeycomb structure between the substrates, providing one substrate with a large number of recesses, or integrally providing partitions for one substrate. Further, it is also possible to enclose the liquid dispersion in microcapsules which are provided between the substrates, such that the liquid dispersion is enclosed between the substrates.

Even if a low specific gravity is attained which is smaller than that of the minute magnets in a conventional reversal magnetic display panel, it is naturally not possible to prevent the minute magnets from sedimenting in the case where the ratio of the specific gravity of the minute magnets to the specific gravity of the liquid which dispersed the minute magnets is large. The specific gravity of the minute magnet/the specific gravity of the liquid in the conventional reversal magnetic display panel is approximately 2.5. If this ratio exceeds 2.2, it is not possible to greatly increase the number of times of the writing/erasing until the multi-pole magnet is needed in which N poles and S poles are arranged at a specific magnetization pitch, as will be described later. Further, if this ratio is less than 0.9, then the minute magnets are so light that the number of times of the writing/erasing cannot be greatly increased either until the multi-pole magnet is needed in which N poles and S poles are arranged at the specific magnetization pitch, since the minute magnets in each cell shift to upper part in the cell due to the repetitions of the writing/erasing by means of a writing magnet or an erasing magnet.

In the present Examples, the specific gravity of the above-mentioned liquid was determined by way of the pycnometer method.

Further, the minute magnets exist in a liquid, and the ratio of the specific gravity of the liquid to the specific gravity of the minute magnets is important, therefore it is necessary for the specific gravity of the minute magnets to determine a true specific gravity.

As a method of determining the specific gravity of the minute magnets, Le Chatelier flask method may be used. However, since it requires 29 ml or more of a sample as a real volume, measurements were carried out by means of a specific gravity adjusting agent which allowed the specific gravity measurements with a small amount of the sample in the present Examples. The used specific gravity adjustment agent is sodium poly tungstate, which is used for mineral separation. In the field of writing materials, it is added to ink to adjust the specific gravity and inhibit a pigment with a large specific gravity, such as a titanium oxide, from sedimenting.

In addition, in the case of measuring the specific gravity, when the minute magnets have poor wettability, a surface active agent may be suitably added in order to improve the wettability.

Further, it is important for the minute magnets that the remanent magnetization of the magnetic property per unit mass is in a range as the follows. The minute magnet requires remanent magnetization to turn its direction as quickly as possible with respect to an external magnetic field, and it contributes to a reversibility characteristic of the minute magnets considerably. If the remanent magnetization is less than 1.0 A·m²/kg, there is a tendency to become difficult to reverse. If it exceeds 23.1 A·m²/kg, there is a tendency for the minute magnets to coagulate together, and thus the good display/erase performance cannot be obtained.

### EFFECTS OF THE INVENTION

According to the present invention, in the reversal magnetic display panel, the minute magnets of the low specific gravity are used. Thus, if it is used in the situation where it is stood, the minute magnets do not easily shift upward or downward in each cell enclosed and formed between the substrates. Therefore, by reducing the ratio of the specific gravity of the minute magnets to the specific gravity of the liquid, it is possible to greatly improve the number of usage times of the writing/erasing until the multi-pole magnet is needed in which N poles and S poles are arranged at the specific magnetization pitch, and a good display/erase performance is obtained.

### BRIEF DESCRIPTION OF THE DRAWINGS

FIG. 1 is a front view of a writing board using a reversal magnetic display panel;

FIG. 2 is a partly schematic vertical sectional view showing the writing board;

FIG. 3 is a schematic view showing a state of cells between substrates of the magnetic display panel;

FIG. 4 is a schematic view showing a dispersion state of minute magnets in a liquid dispersion in the cell;

FIG. 5 is a schematic view showing a dispersion state of the minute magnets in the liquid dispersion in the cell, such that the minute magnets are shifted toward the cell bottom;

FIG. 6 is a perspective view showing an arrangement of the magnets in a maintenance plate;

FIG. 7 is a partly diagrammatic sectional view showing a state where an eraser and a maintenance plate are used; and

FIG. 8 illustrates a cleaner, in which FIG. 8(a) is a perspective view of the cleaner and FIG. 8(b) is an exploded view of the cleaner for explaining its assembly.

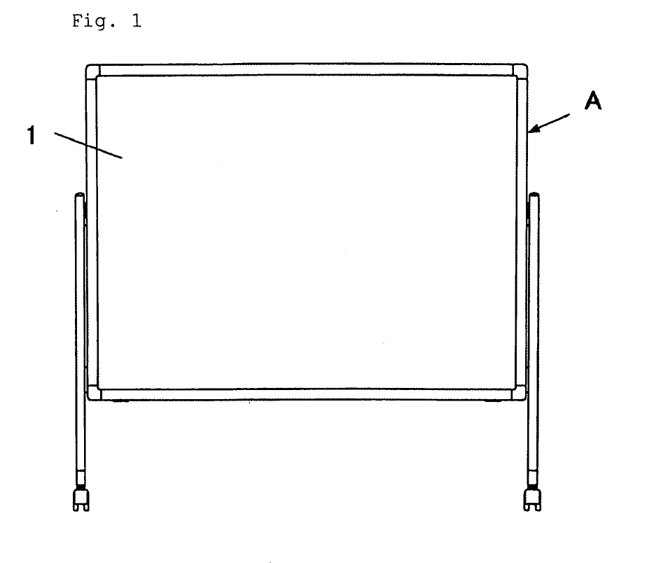

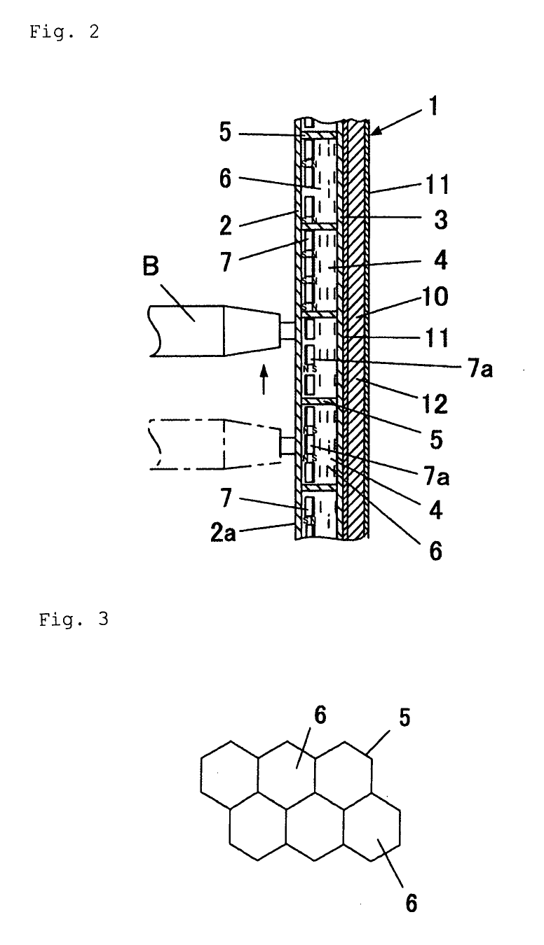

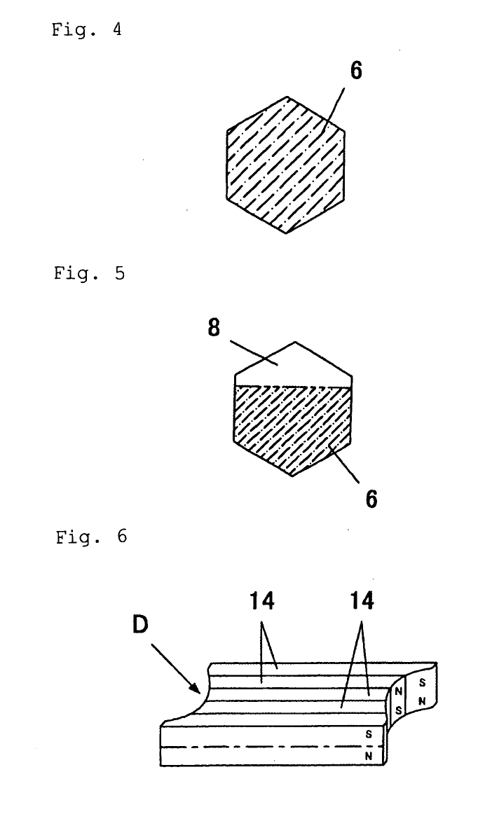

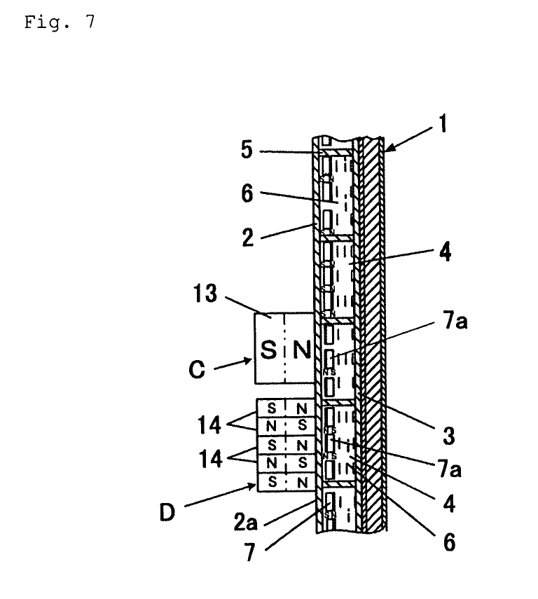

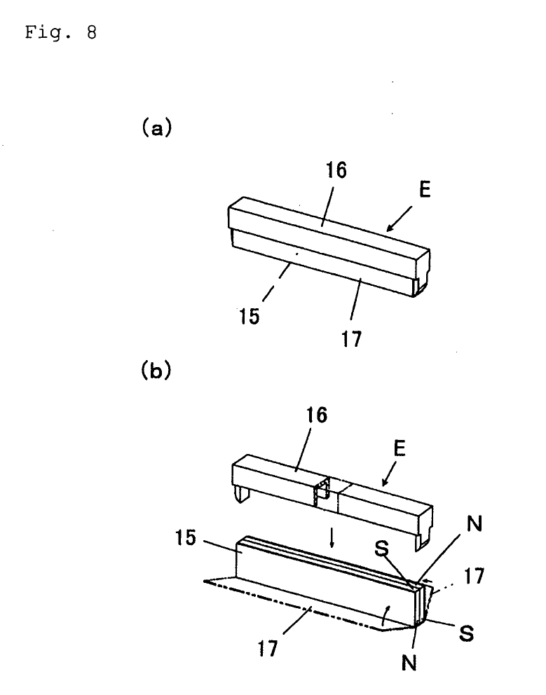

### EXPLANATION OF REFERENCE SIGNS

A: writing board
B: magnetic writing pen
C: eraser
D: maintenance plate
E: cleaner
1: reversal magnetic display panel
2: front substrate
3: back substrate
4: dispersion liquid
6: cell
7: minute magnet

### BEST MODE FOR CARRYING OUT THE INVENTION

A reversal magnetic display panel in accordance with the present invention can be obtained such that minute magnets which include hollow particles and whose remanent magnetization per unit mass is 1.0-23.1 A·m²/kg are dispersed in a liquid having a dispersion medium and a thickener as principal components, to prepare a liquid dispersion, and the liquid dispersion is enclosed between substrates where a large number of cells are formed.

One or more of ferrites, rare earth cobalt, etc. may be used for a magnetic material which constitutes the minute magnet in accordance with the present invention. Examples of the magnetic material are hexagonal magnetoplumbite ferrites, such as a barium ferrite, a strontium ferrite, etc., rare earth cobalts, such as samarium cobalt, cerium cobalt, yttrium cobalt, praseodymium cobalt, etc., a magnetite, maghematite, a cobalt-coated magnetite, a manganese zinc ferrite, a nickel zinc ferrite, a lead ferrite, a rare earth ferrite, chromium dioxide, a neodymium alloy, a samarium-iron-nitrogen alloy, etc.

Preferably, the liquid including the dispersion medium and the thickener as the principal components has a suitable yield point and viscosity. Any of polar dispersion media, such as water and glycols, etc. and non-polar dispersion media, such as organic solvents, oils, etc. can be used as the dispersion medium. Aliphatic hydrocarbon solvents particularly iso paraffin solvents are preferable, since they provide good quality.

Further, the thickener is used for mainly providing the liquid dispersion with the yield point and may be selected from inorganic compounds, such as silicon dioxide, fatty acid bis amide, hydrogenated castor oil, and N-acylamino acid amide. In particular, examples of the thickener include silica, silica hydrate, calcium silicate hydrate, aluminum silicate hydrate, silica powder, diatomite, kaolin, hard clay, soft clay, bentonite, fine powder silicas and fine powder silicates, such as organic bentonite, fine powder alumina, fine calcium carbonates, such as ultra fine calcium carbonate, light calcium carbonate, ultra fine activated calcium, etc., olefin polymers, such as low molecular weight polyethylene, low molecular weight polypropylene, etc., copolymers of olefin and a monomer which can be copolymerized therewith, such as an ethylene-vinyl acetate copolymer, an ethylene-ethyl acrylate copolymer, and an ethylene unsaturated organic acid copolymer, polyalkyl styrene, wax, metal soap, fatty acid amide, dextrin acid fatty acid ester, hydroxy propyl cellulose ester, sucrose fatty acid ester, acyl amino acid ester, starch fatty acid ester, dibenzylidene sorbitol, etc. These thickeners can be used independently or together.

Further, examples of the water-based thickener are natural polysaccharides, such as guar gum and xanthan gum, and synthesized thickeners, such as cross-linked acrylic acid polymer, etc. These thickeners for minute particles can be used independently or together.

In addition, the yield point allows the minute magnets in the liquid dispersion to disperse properly, and the minute magnets are held near the surface when displaying.

It is preferable that the hollow particles included in the minute magnets have an average particle diameter of approximately 0.1-50 μm. In particular, an acrylic copolymer, a styrene copolymer, a styrene acrylic copolymer, a styrene butadiene copolymer, cross-linked materials of these, a glass bead, etc. can be used for the hollow particles.

The liquid for dispersing the minute magnets may be either transparent or translucent. The translucent liquid is prepared such that coloring agents, such as dye, paints, fluorescence dye, etc. may be added thereto.

In addition, it is possible to add an antistatic agent, an antiseptic agent, and an antimicrobial agent to the liquid dispersion of the present invention, if desired.

### EXAMPLES

### Example 1

Firstly,

epoxy resin (emulsion of epoxy with a molecular weight of approximately 3000) . . . 28.5% by weight,

coloring agent (white pigment water-based dispersion) . . . 22.5% by weight, and

hollow particles (water-based dispersion of styrene acrylic copolymer) . . . 49.0% by weight

were blended and a white ink including hollow particles was obtained.

The above-mentioned white ink was applied by means of a wire bar to a PET (polyethylene terephthalate resin) film with a thickness of 25 μm to form a layer having a thickness after drying of 18.0 μm.

Then,

epoxy resin (epoxy resin with a molecular weight of approximately 3000) . . . 27.7% by weight,

magnet powder (a strontium ferrite) . . . 9.8% by weight,

polymeric dispersing agent . . . 0.1% by weight,

coloring agent (green pigment dispersion) . . . 44.0% by weight, and

methyl ethyl ketone . . . 18.4% by weight

were blended to obtain a green ink containing the magnetic powder.

This green ink was applied by the wire bar to the white ink layer including the above-mentioned hollow particles to form a magnetic layer.

Next, the white ink layer face side of the above-mentioned magnetic layer was magnetized to be an S pole, the opposite surface side was magnetized to be an N pole, and the magnetic layer was peeled from the PET film and ground by a grinder to obtain minute magnets. When measured by way of the measuring method as described above, the specific gravity of the minute magnets was 1.3 and a thickness was 21 μm. Remanent magnetization was measured by means of VIBRATING SAMPLE MAGNETOMET ER VSM-P7 manufactured by Toei Kabushiki Kaisha, and it was 1.0 A·m²/kg.

Next, a thickener comprising ethylene bis-12-hydroxy stearic acid amide was added to a dispersion medium comprising an iso paraffin solvent. Further, the antistatic agent was added thereto and stirred, so that the liquid of the following compounding ratios was prepared.

dispersion medium (an iso paraffin hydrocarbon) . . . 97.9% by weight,

thickener (ethylene bis-12-hydroxy stearic acid amide) . . . 2.0% by weight,

antistatic agent (nitrogen-containing polymeric compound and sulfur-containing compound) . . . 0.1% by weight.

The specific gravity of this liquid was 0.8 when measured by way of the measuring method as described above.

The minute magnets prepared as described above were dispersed into this liquid to obtain the liquid dispersion. The yield point of this liquid dispersion was 1.0 N/m² when measured by way of a direct method using a Brookfield type viscometer. The specific gravity of the minute magnets/the specific gravity of the liquid was 1.6.

The above-mentioned liquid dispersion was poured into a display panel member in which a honeycomb made from polyvinyl chloride having a thickness of 1.3 mm, a cell wall thickness of 0.04 mm, and a cell size of 4 mm was adhered to a polyvinyl chloride transparent substrate with a thickness of 0.3 mm by using an ethylene-vinyl acetate emulsion adhesive, onto which a polyvinyl chloride transparent substrate with a thickness of 0.08 mm was adhered by using an epoxy adhesive, to thereby prepare a reversal magnetic display panel in accordance with the present invention.

### Examples 2-9

As with Example 1, the minute magnets having thicknesses, specific gravities, and remanent magnetization values as shown in Examples 2-9 of Tables 1 and 2, and the liquids having specific gravities as shown in Examples 2-9 of Tables 1 and 2 were prepared. The above-mentioned minute magnets were dispersed in these liquids to obtain the liquid dispersions.

After that, as with Example 1, the reversal magnetic display panels of the present invention were prepared. The yield point of each liquid dispersion and the values of the specific gravities of the minute magnets/the specific gravities of the liquids are as shown in Tables 1 and 2.

### Comparative Example 1

Minute magnets equivalent to those for a conventional reversal magnetic display panel, but not including hollow particles, were obtained similarly to Example 1 and dispersed in a liquid prepared similarly to Example 1 and having a specific gravity as shown in Comparative Example 1 of Table 2, to thereby obtain a liquid dispersion.

After that, as with Example 1, a reversal magnetic display panel was prepared. A thickness, a specific gravity, and a remanent magnetization value of the minute magnets, a specific gravity of the liquid, a yield point of the liquid dispersion, and a value of the specific gravity of the minute magnets/a specific gravity of the liquid are as shown in Table 2.

In this comparative example, the specific gravity of the minute magnets/the specific gravity of the liquid was 2.5.

### Comparative Examples 2 and 3

Minute magnets having thicknesses, specific gravities, and remanent magnetization values as shown in Table 2, and liquids having specific gravities as shown in Table 2 were prepared. The above-mentioned minute magnets were dispersed in the respective liquids to obtain liquid dispersions.

After that, as with Example 1, reversal magnetic display panels were prepared respectively. Yield points of the respective liquid dispersions and respective value of the specific gravities of the minute magnets/the specific gravities of the liquids are as shown in Table 2.

### Examination and Evaluation

The reversal magnetic display panels of Examples 1-9 and Comparative Examples 1-3 were formed in writing boards, and evaluated by performing the following examinations.

In a situation where the above-mentioned reversal magnetic display panel is stood, a solid line is written to have loops with a diameter of 80 mm by means of a magnet having a diameter of 2 mm and a surface magnetic flux density of 118 mT, at a travel speed of 100 mm/sec and at a rotation speed of 120 rpm, from the left corner to the right corner or from the right corner to the left corner of the panel. Each time the writing is carried out, an eraser having the magnet with a surface magnetic flux density of 64 mT and eliminating the writing is reciprocated once at a travel speed of 300 mm/sec, from the left corner to the right corner or from the right corner to the left corner of the panel.

In order to align the minute magnets in the panel which are reversed incorrectly, on completion of the writing/erasing 20 times, a cleaner E which has a surface magnetic flux density of 75 mT and arranges in parallel N pole and S pole of a magnet 15 as shown in FIG. 8 is shuttled on the panel three times at a travel speed of 600 mm/sec, from the left corner to the right corner or from the right corner to the left corner of the panel. Such operation is repeated to carry out writing/erasing, and a sedimentation condition of the minute magnets in the reversal magnetic display panel is checked visually.

The reason for using the cleaner E is that in the case where the writing/erasing is repeated more than predetermined times, some of single poles (for example, N pole) may not be reversed correctly but inclined in trying to re-reverse the reversed minute magnets 7a by using the eraser C in order to erase the handwriting, and that when such minute magnets reversed incorrectly increase in number, clear handwriting/erasing may not be obtained.

In addition, in FIG. 8, reference numeral 16 is a resin case and reference numeral 17 is a protection sheet member.

As for the honeycomb-like cells in the magnetic display panel, the number of times of the writing/erasing was checked until a cell in which the minute magnets in approximately 30% part of cell's surface area were shifted upwards or downwards began to appear.

Evaluations are as follows:

⊚ Double Circles (Excellent): after 5000 or more repetitions of the writing/erasing, there appeared no cells whose minute magnets were shifted upwards or downwards.

◯ Single Circle (Good): there appeared a cell whose minute magnets were shifted upwards or downwards, after 2000 to 4999 repetitions of the writing/erasing.

Δ Triangle (Fair): there appeared a cell whose minute magnets were shifted upwards or downwards, after 1000 to 1999 repetitions of the writing/erasing.

X Cross (No Good): as with the conventional one, there appeared a cell whose minute magnets were shifted upwards or downwards, after 999 or less repetitions of the writing/erasing.

Further, the written lines were visually checked to see if they were blurred or became unclear, because of coagulation of the minute magnets or the incorrectly reversed minute magnets. A written line in which neither a blur nor an indistinct portion took place was evaluated as being good (◯ Single Circle). A written line in which a blur or an indistinct portion took place was evaluated as being no good (X Cross).

In comprehensive evaluation, one whose evaluation of the repetitions of the writing/erasing was excellent (⊚ Double Circles) and whose handwriting status was good (◯Single Circle) was evaluated as being excellent (⊚ Double Circles). One whose evaluation of the repetitions of the writing/erasing was good (◯ Single Circle) and whose handwriting status was good (◯ Single Circle) was evaluated as being good (◯ Single Circle). One whose evaluation of the repetitions of the writing/erasing was fair (Δ Triangle) and whose handwriting status was good (◯ Single Circle) was evaluated as being fair (Δ Triangle). One whose evaluation of the repetitions of the writing/erasing was no good (X Cross) or whose handwriting status was no good (X Cross) was evaluated as being no good (X Cross).

In addition, although not appeared this time in Examples or Comparative Examples, one whose handwriting status is no good (X Cross) is comprehensively evaluated as being no good (X Cross), even if it's writing/erasing repetition evaluation is excellent (⊚ Double Circles), good (◯ Single Circle), or fair (Δ Triangle).

The resulting evaluations of Examples and Comparative Examples are as shown in Table 1 and 2.

TABLE 1

| | | Examples | | | | | |
|---|---|---|---|---|---|---|---|
| | | 1 | 2 | 3 | 4 | 5 | 6 |
| Minute | Thickness (μm) | 21 | 24 | 22 | 23 | 25 | 33 |
| Magnets | Specific Gravity | 1.3 | 1.9 | 1.8 | 1.5 | 1.1 | 1.3 |
| | (existence of hollow | (Present) | (Present) | (Present) | (Present) | (Present) | (Present) |
| | particles) | | | | | | |
| | Remanent | 1.0 | 1.6 | 1.8 | 2.1 | 2.6 | 1.9 |
| | Magnetization | | | | | | |
| | value (A · m²/Kg) | | | | | | |
| Liquid | Specific Gravity | 0.8 | 0.8 | 0.8 | 0.8 | 0.8 | 1.6 |
| Liquid | Yield Point (N/m²) | 1.0 | 1.5 | 1.5 | 1.9 | 1.4 | 0.8 |
| Dispersion | | | | | | | |

| | | | | | | |
|---|---|---|---|---|---|---|
| Specific Gravity of Minute | 1.6 | 2.4 | 2.2 | 1.9 | 1.4 | 0.8 |
| Magnets/Specific Gravity of Liquid | | | | | | |
| Number of Continual Repetitions of | 5000 or | 1800 | 2500 | 5000 or | 5000 or | 1500 |
| Writing/Erasing Until 30% of | more | | | more | more | |
| Minute Magnets are shifted | | | | | | |
| Evaluation | ⊚ | Δ | ◯ | ⊚ | ⊚ | Δ |
| Handwriting Status | ◯ | ◯ | ◯ | ◯ | ◯ | ◯ |
| Comprehensive Evaluation | ⊚ | Δ | ◯ | ⊚ | ⊚ | Δ |

TABLE 2

| | | Examples | | | Comparative Examples | | |
|---|---|---|---|---|---|---|---|
| | | 7 | 8 | 9 | 1 | 2 | 3 |
| Minute | Thickness (μm) | 23 | 33 | 33 | 22 | 33 | 20 |
| Magnets | Specific Gravity | 1.5 | 1.3 | 1.7 | 2 | 1.8 | 1.3 |
| | (existence of hollow | (Present) | (Present) | (Present) | (Absent) | (Present) | (Present) |
| | particles) | | | | | | |
| | Remanent | 2.1 | 1.9 | 23.1 | 1.6 | 30.1 | 0.8 |
| | Magnetization | | | | | | |
| | value (A · m²/Kg) | | | | | | |
| Liquid | Specific Gravity | 1.6 | 1.3 | 0.8 | 0.8 | 0.8 | 0.8 |
| Liquid | Yield Point (N/m²) | 0.8 | 0.8 | 4.6 | 1.4 | 4.6 | 0.8 |
| Dispersion | | | | | | | |

| | | | | | | |
|---|---|---|---|---|---|---|
| Specific Gravity of Minute | 0.9 | 1.0 | 2.2 | 2.5 | 2.2 | 1.6 |
| Magnets/Specific Gravity of Liquid | | | | | | |
| Number of Continual Repetitions of | 2300 | 5000 or | 4000 | 500 | 2000 | — |
| Writing/Erasing Until 30% of | | more | | | | |
| Minute Magnets are shifted | | | | | | |
| Evaluation | ◯ | ⊚ | ◯ | X | ◯ | — |
| Handwriting Status | ◯ | ◯ | ◯ | ◯ | X | X |
| Comprehensive Evaluation | ◯ | ⊚ | ◯ | X | X | X |

In Examples in which the hollow particles included in the minute magnets, it was confirmed that the number of times of the writing/erasing until a cell whose minute magnets were shifted upwards or downwards in the cell was improved since it was twice or more larger than that of the conventional reversal magnetic display panel.

By selecting the ratio of the specific gravity of the minute magnets to the specific gravity of the liquid having the dispersion medium and the thickener as the principal components to be 0.9-2.2, the number of times of the writing/erasing is four times or more larger than that of the conventional one.

Furthermore, by selecting the ratio of the specific gravity of the minute magnets to the specific gravity of the liquid having the dispersion medium and the thickener as the principal components to be 1.0-1.9, the advantageous effects are increased and the number of times of the writing/erasing is 10 times or more than that of the conventional one.

In Comparative Example 1, the minute magnets were for the conventional reversal magnetic display panel, and the hollow particles were not included. Therefore, the value of the specific gravity of the minute magnets/the specific gravity of the liquid was as high as 2.5, and there appeared a cell whose minute magnets were shifted upward or downward when the number of times of the writing/erasing exceeded around 500.

In Comparative Example 2, the hollow particles were included in the minute magnets. Although, the number of times of the writing/erasing was 4 times that of the conventional one, the remanent magnetization was 30.1 A·m²/kg. As the writing/erasing was repeated, the minute magnets coagulated together. Thus, the written line became blurred, and did not satisfy display/erase performances as the magnetic display panel.

In Comparative Example 3, although the hollow particles were included in the minute magnets, the remanent magnetization was 0.8 A·m²/kg. Thus, the minute magnets were not reversed smoothly, and some of the minute magnets were not reversed, so as not to satisfy display/erase performances as the magnetic display panel.

### INDUSTRIAL APPLICABILITY

Even if the reversal magnetic display panel in accordance with the present invention is used in the situation where it is stood, it is possible to greatly improve the number of times of the writing/erasing until the minute magnets included in the liquid dispersion enclosed between the substrates need a multi-pole magnet in which N poles and S poles are arranged at the specific magnetization pitch, since they are shifted due to the repetitions of the writing/erasing. Further, since good display/erase performance can be obtained, it is possible to reduce the number of times of work for returning the above-mentioned minute magnets to their original state, and it is effective in use as the writing board and a large-sized writing board for clean rooms.

1. A reversal magnetic display panel, in which a liquid dispersion where minute magnets having different colors in the front and back are included in a liquid having a dispersion medium and a thickener as principal components is enclosed between substrates, so that handwriting is formed by way of a difference in contrast between a color of the minute magnet which is reversed and that of the minute magnet which is not reversed, characterized in that said minute magnets include hollow particles, and remanent magnetization per unit mass of said minute magnets is 1.0-23.1 A·m²/kg.

2. The reversal magnetic display panel as claimed in claim 1, characterized in that a ratio of a specific gravity of said minute magnets to a specific gravity of the liquid having the dispersion medium and the thickener as the principal components is 0.9-2.2.

3. The reversal magnetic display panel as claimed in claim 2, characterized in that the ratio of the specific gravity of said minute magnets to the specific gravity of the liquid having the dispersion medium and the thickener as the principal components is 1.0-1.9.
